(19) United States
(12) Patent Application Publication
(10) Pub. No.: US 2024/0298209 A1
(43) Pub. Date: Sep. 5, 2024

(54) DETERMINISTIC COMMUNICATION WITH TIME SENSITIVE NETWORKING IN A TRANSPORT NETWORK

(71) Applicant: ZTE Corporation, Shenzhen (CN)

(72) Inventors: Zhendong Li, Shenzhen (CN); Jinguo Zhu, Shenzhen (CN); Xingming Zheng, Shenzhen (CN)

(73) Assignee: ZTE Corporation, Shenzhen (CN)

(21) Appl. No.: 18/661,269

(22) Filed: May 10, 2024

Related U.S. Application Data
(63) Continuation of application No. PCT/CN2022/083256, filed on Mar. 28, 2022.

(51) Int. Cl. H04W 28/02; H04L 47/28

(52) U.S. Cl. CPC H04W 28/0268; H04L 47/28

(57) ABSTRACT

Deterministic packet delivery in a network can be improved. For example, a Time Sensitive Networking (TSN) capability for a transport network may be provided by a basestation, so TSN can be used in the transport network. During Quality of Service (QoS) flow establishment, stream requirements may be transmitted. A latency requirement of QoS may be obtained as part of a deterministic latency used for delivering traffic or improved transport.

### CROSS-REFERENCE TO RELATED APPLICATIONS

This application is a continuation of co-pending International Patent Application No. PCT/CN2022/083256, filed Mar. 28, 2022. The contents of International Patent Application No. PCT/CN2022/083256 are herein incorporated by reference in their entirety.

### TECHNICAL FIELD

This document is directed generally to wireless communications. More specifically, enhancements are made to a transport network with Time Sensitive Networking (TSN).

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, improvements should be made to maintain and ensure the speed and quality of service standards.

### SUMMARY

This document relates to methods, systems, and devices for improving deterministic packet delivery in a network. For example, a Time Sensitive Networking (TSN) capability may be provided in a transport network between a basestation and UPF, so TSN can be used in the transport network. During Quality of Service (QoS) flow establishment, stream requirements may be transmitted. A latency requirement of QoS flow in the transport network may be obtained as part of a deterministic latency used for delivering traffic or improved transport.

In one embodiment, a method for wireless communication includes obtaining a Time Sensitive Networking (TSN) capability, and obtaining a latency requirement. The obtaining the TSN capability is by a TSN Centralized User Configuration Function (TSNCF). The obtaining the TSN capability is during a Packet Data Unit (PDU) session establishment or Quality of Service (QoS) flow setup. The method includes obtaining stream requirement for the QoS flow setup. The stream requirement comprises stream information, stream time information, a basestation address, or a User Plane Function (UPF) address. The obtaining of the latency requirement further includes receiving, by a TSN Centralized User Configuration Function (TSNCF), the CN PDB from a basestation, a Session Management Function (SMF), or a Policy Control Function (PCF). The method includes sending, by a TSN Centralized User Configuration Function (TSNCF), a talker/listener status to a Centralized Network Configuration (CNC). The method includes receiving, by the TSNCF, a configuration from Centralized Network Configuration (CNC), and sending, by the TSNCF, the configuration to a basestation and a User Plane Function (UPF). The TSNCF comprises a TSN Application Function (TSN AF), a Policy Control Function (PCF), a Session Management Function (SMF), or a Time Sensitive Communication and Time Synchronization function (TSCTSF). The latency requirement comprises a Core Network Packet Delay (CN PDB) latency.

In another embodiment, a method for wireless communication includes sending a Time Sensitive Networking (TSN) capability, and sending during a Quality of Service (QoS) flow establishment, a stream requirement. The sending, is by the basestation or User Plane Function (UPF). The sending is to a TSN Centralized User Configuration Function (TSNCF) and is during a Packet Data Unit (PDU) session establishment or Quality of Service (QoS) flow setup. The stream requirement comprises stream information, stream time information, or a basestation address or User Plane Function (UPF) address. The method includes sending a latency requirement. The sending the latency requirement is by a basestation, a Session Management Function (SMF), or a Policy Control Function (PCF). The latency requirement comprises a Core Network Packet Delay (CN PDB) latency.

In another embodiment, a method for wireless communication includes obtaining a Time Sensitive Networking (TSN) capability, and obtaining, during a during a Quality of Service (QoS) flow establishment, a stream requirement. The obtaining the TSN capability is by a TSN Centralized User Configuration Function (TSNCF). The obtaining the TSN capability is during a Packet Data Unit (PDU) session establishment or Quality of Service (QoS) flow setup. The method includes obtaining a Core Network Packet Delay Budget (“CN PDB”) latency requirement. The obtaining of the latency requirement includes receiving, by a TSN Centralized User Configuration Function (TSNCF), the CN PDB from a basestation, a Session Management Function (SMF), or a Policy Control Function (PCF). The method includes sending, by the TSNCF, a talker/listener status to a Centralized Network Configuration (CNC). The method includes receiving, by the TSNCF, a configuration from a Centralized Network Configuration (CNC), and sending, by the TSNCF, the configuration to a basestation and a User Plane Function (UPF). The TSNCF comprises a TSN Application Function (TSN AF), a Policy Control Function (PCF), a Session Management Function (SMF), or a Time Sensitive Communication and Time Synchronization function (TSCTSF). The stream services requirement comprises stream information, stream time information, or a basestation address, or a User Plane Function (UPF) address.

In another embodiment, a wireless communications apparatus comprising a processor and a memory, wherein the processor is configured to read code from the memory and implement any of the methods for wireless communication described herein.

In another embodiment, a computer program product comprising a computer-readable program medium code stored thereupon, the code, when executed by a processor, causing the processor to implement any of the methods for wireless communication described herein.

### BRIEF DESCRIPTION OF THE DRAWINGS

FIG. 1 shows an example basestation.

FIG. 2 shows an example random access (RA) messaging environment.

FIG. 3 shows an embodiment of a centralized mode network architecture.

FIG. 4 shows an embodiment of an enhanced network with a Time Sensitive Networking (TSN) enabled transport network architecture.

FIG. 5 shows an embodiment of centralized mode communications.

FIG. 6 shows an embodiment of Time Sensitive Networking (TSN) information communication.

FIG. 7 shows another embodiment of Time Sensitive Networking (TSN) information communication during a Packet Data Unit (PDU) session establishment.

FIG. 8 shows an embodiment of Time Sensitive Networking (TSN) information communication during a Quality of Service (QoS) flow establishment.

FIG. 9 shows an embodiment of transport network with latency communications.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

New Radio Access (NR) includes a packet delay budget (“PDB”) to improve the quality of service (QoS) requirements for reliability. For one Qos flow, the PDB is a certain value refer to packet delay between UE and User Plane Function (UPF). The PDB may include an Access Network PDB (AN PDB) and a Core Network PDB (“CN PDB”) and may be referred to as total PDB. The CN PDB may be calculated by the UPF or the Next Generation Radio Access Network (NG-RAN)/basestation. The RAN may be a part of a wireless communication system that connects UE devices to other parts of a network through radio or wireless connections. In a NR system, including 5^{th} generation networks (5G or 5GS), the QoS may be a necessary feature for reliability. There may be a number of QoS characteristics that are part of a QoS flow in a packet data unit (PDU) session.

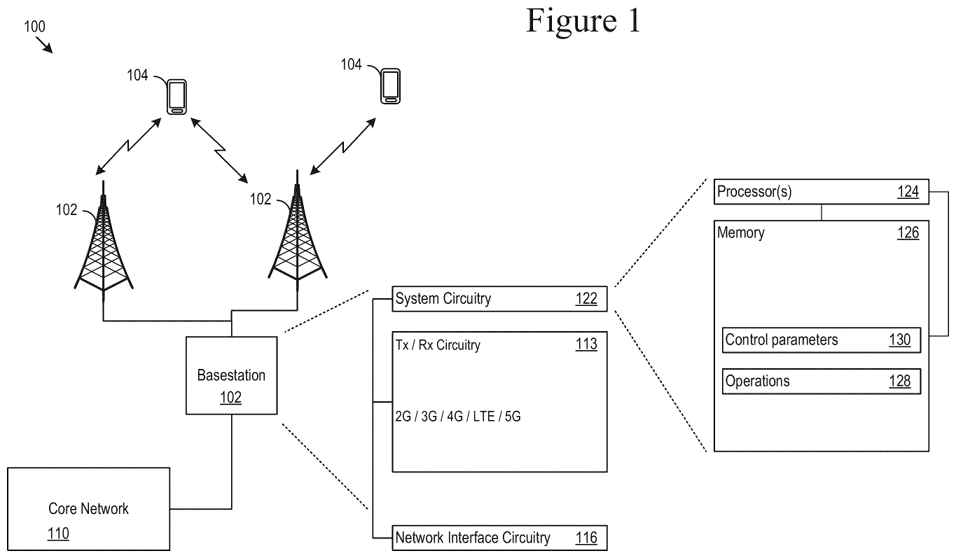

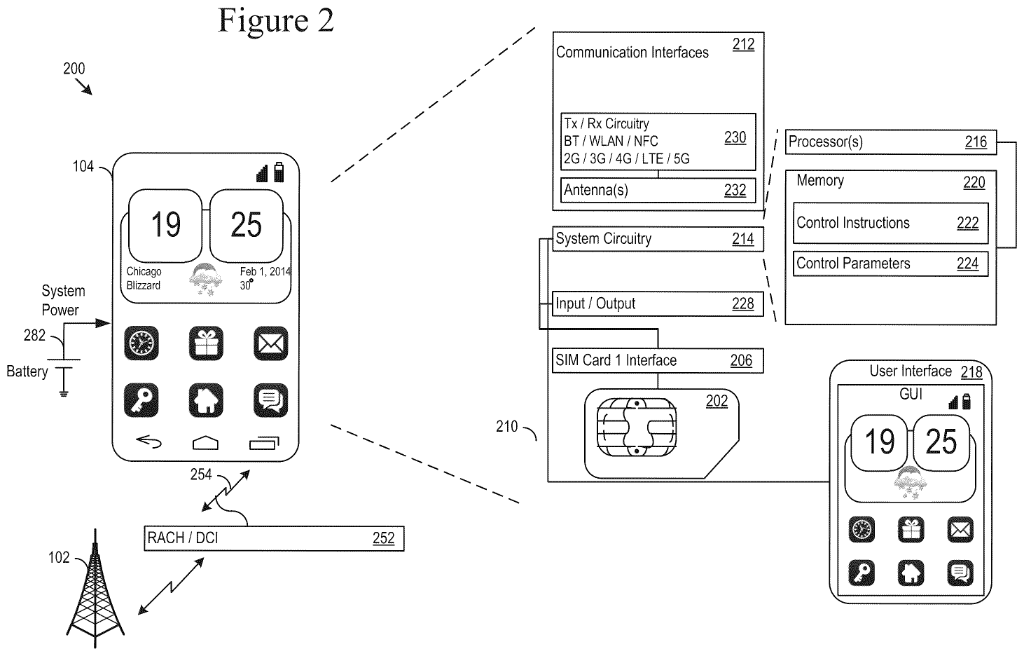

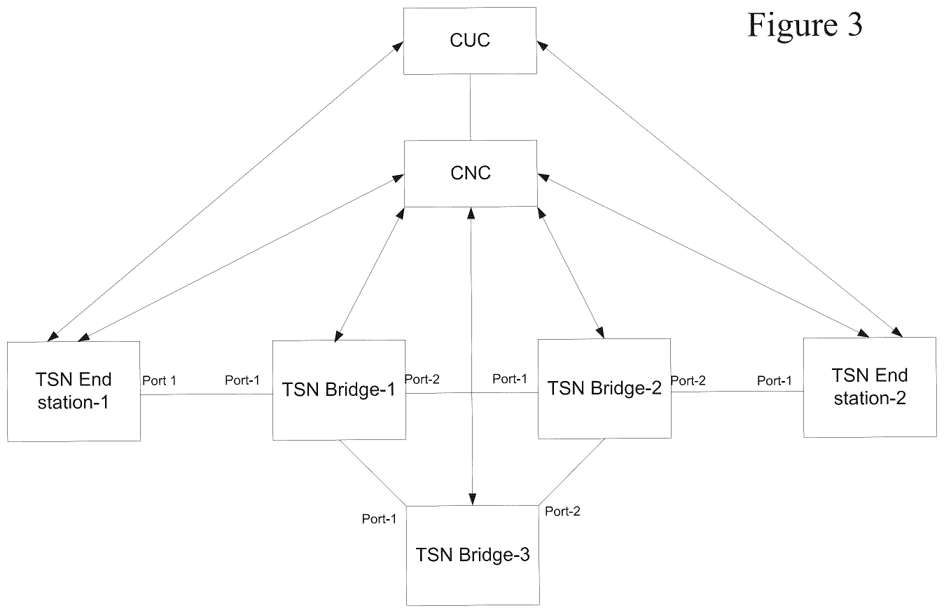

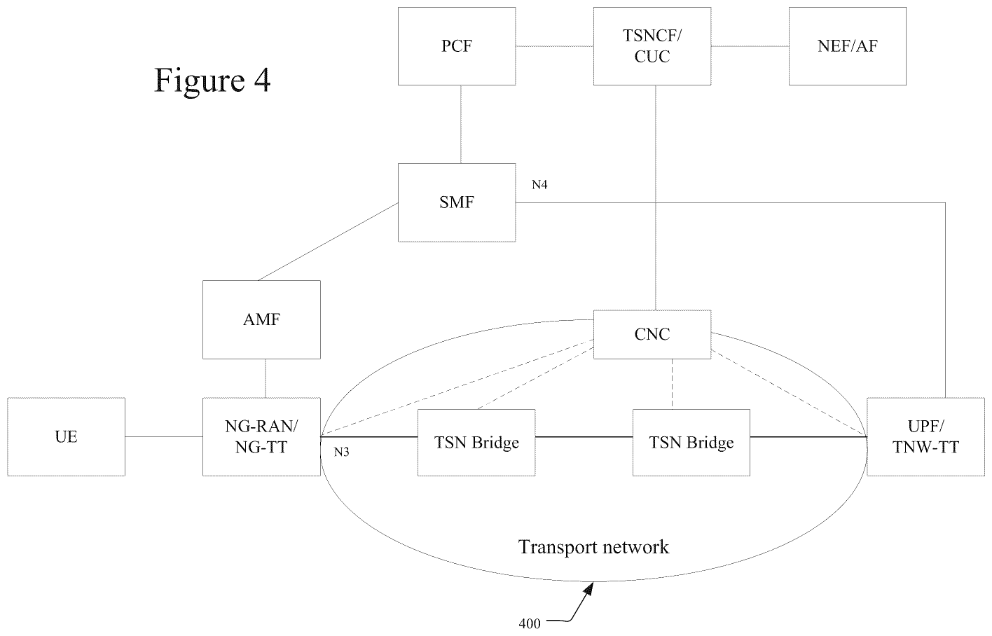

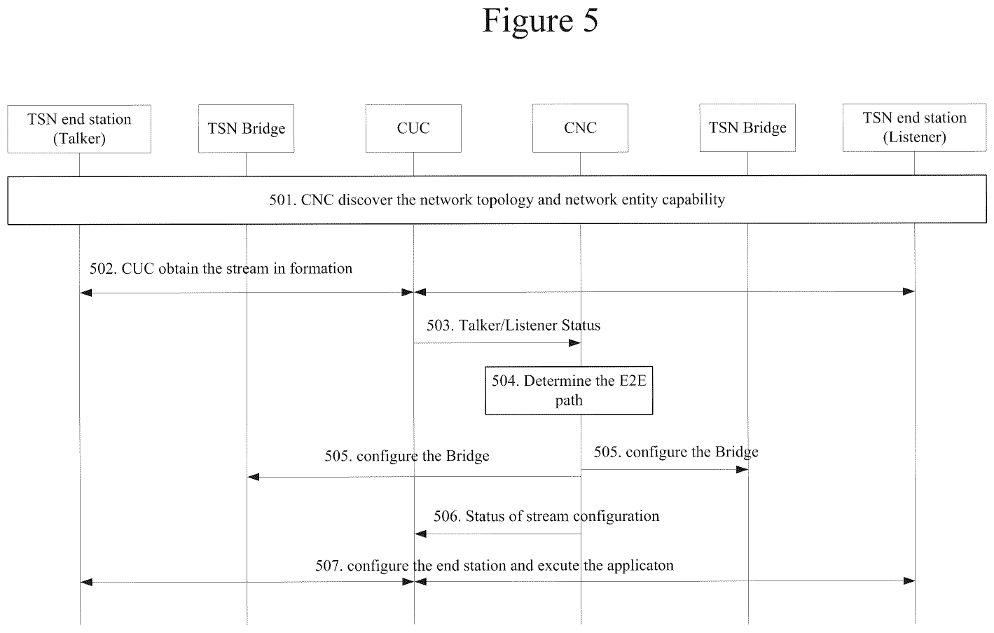

A periodic deterministic communication service uses deterministic latency to deliver traffic in the NR. The latency may include an air interface (i.e. radio) latency, such as AN PDB. The AN PDB may be from a user equipment to a basestation. The latency may include N3 transport latency, such as CN PDB. The CN PDB may be between a RAN node and a user plane function (UPF). A transport network deployed for the N3 interface may not be able to provide deterministic latency packet deliver. Time Sensitive Networking (TSN) may provide deterministic packet delivery in the network. If the transport network supports TSN, then there may be deterministic packet delivery capability in the transport network, which can achieve the deterministic latency to deliver traffic. The embodiments describe enhancements to a network (e.g. 5GS) to utilize the TSN capability in a transport network. FIG. 1 illustrates an example NG-RAN or basestation. FIG. 2 illustrates an example random access messaging environment. FIGS. 3-4 illustrate an example architecture for a transport network and 5GS. FIGS. 5-9 illustrate examples of communications in a transport network and 5GS. The embodiments can improve deterministic packet delivery in a network. For example, a Time Sensitive Networking (TSN) capability for a transport network may be provided by a basestation and UPF, so TSN can be used in the transport network. During Quality of Service (QoS) flow establishment, stream requirements may be transmitted. A latency requirement of QoS flow may be obtained as part of a deterministic latency used for delivering traffic or improved transport.

FIG. 1 shows an example basestation 102. The basestation 102 may also be referred to as a wireless network node or a next generation radio access network (“NG-RAN”) node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

FIG. 3 shows an embodiment of a centralized mode TSN network architecture. The centralized mode network architecture includes a Centralized User Configuration (CUC) and a Centralized Network Configuration (CNC). There can be a number of Time Sensitive Networking (TSN) end stations and bridges. The example in FIG. 3 includes three TSN Bridges and two TSN end stations. Service traffic flows between the TSN end stations through TSN bridges. A TSN end station that sends a packet/frame may be referred to as a “talker”, while the TSN end station that receives the packet/frame may be referred to as a “listener.” For example, when the service traffic is from TSN end station 1 to TSN end station 2, then TSN end station 1 is the talker and TSN end station 2 is the listener. A TSN end station which both sends and receives packets/frames is both a talker and a listener.

The CUC discovers TSN end stations and retrieves end station capabilities and user requirements for communication. This may also be referred to as stream information. The communication requirements, or stream information can be sent to the CNC. The information may include related TSN end station information, such as capabilities, that are sent to the CNC. When the CUC receives the configuration information from the CNC, the CUC can configure TSN features in the end stations.

The CNC in the TSN network may control or configure the TSN nodes (e.g. end stations and bridges) within the TSN network. The nodes may each report their capability and neighborhood topology to the CNC. The CNC can use the capability information to construct the TSN network topology through topology discovery. The CNC can use stream information and related TSN end station information from CUC to decide whether a TSN stream should be established. The CNC can determine an end to end path (e.g. end station to end station) for the stream. The path may be determined by considering the sender (i.e. the talker), the receiver (i.e. the listener), other TSN nodes, TSN node capabilities, link capabilities, and/or TSN network topology.

After calculating the path, the CNC configure a TSN Bridge with a forwarding rule and/or configures the TSN Bridge with a scheduling schema. When the data frame/packet arrives at the TSN bridge, the TSN bridge knows how to handle it based on the forwarding rule and/or the scheduling schema. Specifically, it knows which port to forward the received packet/frame. The CNC may also send the configuration for the TSN end station to the CUC. The CUC can send the configuration to TSN end stations. As described below, FIG. 5 illustrates a full centralized mode embodiment.

FIG. 4 shows an embodiment of an enhanced network (e.g. 5GS) architecture to utilize TSN capability in the transport network. This architecture is merely one example and there may be more or fewer components for implementing the embodiments described herein. Two interconnections or communications between components are identified as N3 and N4, which may be referred to by other Figures. The other interconnections are not labeled. This architecture makes use of Time Sensitive Networking (TSN) capability within a transport network. Specifically, the transport network 400 includes one or more TSN bridges and the CNC. As shown, the N3 interface is between the basestation (NG-RAN) and a user plane function (UPF) for user plane packet delivery. The transport network (which can include several Routers, Bridges, etc.) provides the functionality of N3 interface. The components are described below.

A user equipment (UE) is accessing a wireless communication service (e.g. 5GS) and obtains services via a basestation (NG-RAN) and interacts with an Access and Mobility Control Function (AMF) of the core network via the non-access stratum (NAS) signaling. FIG. 2 illustrates an example user equipment (“UE”) 104. FIG. 1 illustrates an example basestation or NG-RAN 102. The NG-RAN node may be responsible for the air interface resource scheduling and air interface connection management of the network to which the UE accesses. The AMF may include the following functionalities: Registration management, Connection management, Reachability management and Mobility Management. The AMF may also perform the access authentication and access authorization. The AMF may be the NAS security termination and relay the session management NAS between the UE and the SMF, etc.

The SMF may include the following functionalities: Session Management e.g. Session establishment, modify and release, UE IP address allocation & management (including optional Authorization), Selection and control of uplink function, downlink data notification, etc. The user plane function (“UPF”) may include the following functionalities: Anchor point for Intra-/Inter-RAT mobility, Packet routing & forwarding, Traffic usage reporting, Quality of Service (QoS) handling for user plane, downlink packet buffering and downlink data notification triggering, etc. A Policy Control Function (PCF) may include the following functionality: supporting a unified policy framework to govern network behavior, providing policy rules to Control Plane function(s) to enforce the policy rule, implementing a Front End to access subscription information relevant for policy decisions in a User Data Repository (UDR). A Network Exposure Function (NEF) is deployed optionally for exchanging information between a network (e.g. 5GS) and an external Application Function (AF). In one embodiment, an Application Function (“AF”) may store the application information in the Unified Data Repository via NEF. The UPF communicates with a data network. The NEF/AF are shown together in FIG. 4, though they may be separate is some embodiments.

Although not shown, there may be a Unified Data Management (“UDM”) that manages the subscription profile for the UEs. The subscription includes the data used for mobility management (e.g. restricted area), session management (e.g. QoS profile). The subscription data also includes slice selection parameters, which are used for AMF to select a proper SMF. The AMF and SMF may get the subscription from the UDM. The subscription data may be stored in a Unified Data Repository with the UDM, which uses such data upon reception of request from AMF or SMF.

For the transport network to have TSN support, the following components may be utilized along with the transport network 400. A basestation/NG-RAN TSN Translator (NG-TT) has TSN translator (TT) functionality that is in the basestation. The functionality may include interoperation between TSN in a transport network and the wireless communication network (i.e. a cellular network or 5G). In addition, the NG-TT implements the functionality of the TSN end station in a TSN network. In some embodiments, the NG-TT may be located with the basestation/NG-RAN.

A Transport Network TSN Translator (TNW-TT) may include TSN Translator (TT) functionality in the UPF. The functionality may include interoperation between TSN in the transport network and the wireless communication network (i.e. a cellular network or 5G). In addition, the TNW-TT may implement the functionality of the TSN end station in a TSN network. In some embodiments, the NG-TT may be located with the UPF.

A TSN CUC Function (TSNCF) may function as the CUC to the TSN network or to the CNC. In the cellular/5G network, the TSNCF interacts with the NG-TT and the TNW-TT to collect stream information, TSN end station information, or other TSN information. In some embodiments, the TSNCF may be a TSN AF, SMF, or TSCTSF in the existing network, or it may be a new network function.

FIG. 5 shows an embodiment of TSN centralized mode communications. In some embodiments, the centralized mode communications may be based on communications within the network architecture shown in FIG. 3. In block 501, the nodes (e.g. TSN end station and/or TSN Bridge) in the TSN network report their capability and neighborhood topology to the CNC. The CNC uses this reported capability and information to calculate the network topology. In block 502, the CUC communicates with the TSN end station for the stream information, which in some embodiments may include a MAC address, a service requirement, a priority, etc. In block 503, the CUC provides a talker and listener status to the CNC, which may include a stream ID, stream information, a talker and listener group for the stream, and stream QoS information. In block 504, the CNC calculates the E2E path for the stream. In block 505, the CNC configures the TSN Bridge for stream forwarding. It may include a destination MAC address, a VLAN ID, and/or a port MAP containing a control element for each outbound port. In some embodiments, if the destination MAC address, or destination MAC address and VLAN ID of a received packet/frame match the rule, then the packet/frame can be forwarded in the corresponding outbound port. In block 506, the CNC responds to the CUC with a status of stream configuration, including the configuration for the TSN end station. The configuration may include which entities are the talker/listener. In block 507, the CUC configures the TSN end station to execute the application.

The transport and 5GS architectures and networks shown in FIGS. 1-5 may be used to implement the TSNCF obtaining the TSN capability for the transport network from NG-RAN/NG-TT and UPF/TNW-TT. This may be during a PDU session establishment, or QoS flow setup. In addition, the transport and 5GS architectures and networks shown in FIGS. 1-5 may be used to implement the providing of a stream requirement during QoS flow establishment. The stream requirement may be from NG-TT and/or TNW-TT to the TSNCF. The stream requirement may include an NG-TT/TNW-TT address (e.g. talk/listener MAC address), an interface name, stream information, and/or stream time information. In addition, the transport and 5GS architectures and networks shown in FIGS. 1-5 may be used to implement the TSNCF obtaining a latency requirement. The latency requirement may include a Core Network Packet Delay Budget (“CN PDB”) latency of QoS flow in the N3 transport. In some examples, the NG-RAN may send the CN PDB of QoS flow to TSNCF; the SMF sends the CN PDB of QoS flow to TSNCF; or the PCF sends the CN PDB of QoS flow to TSNCF. The TSNCF may send the talker/listener status to CNC. When the TSNCF receives a configuration from the CNC, it can send it to NG-TT and TNW-TT. The TSNCF may be TSN AF, PCF, SMF, or TSCTSF in the cellular/5GS network, or it may be a new network function.

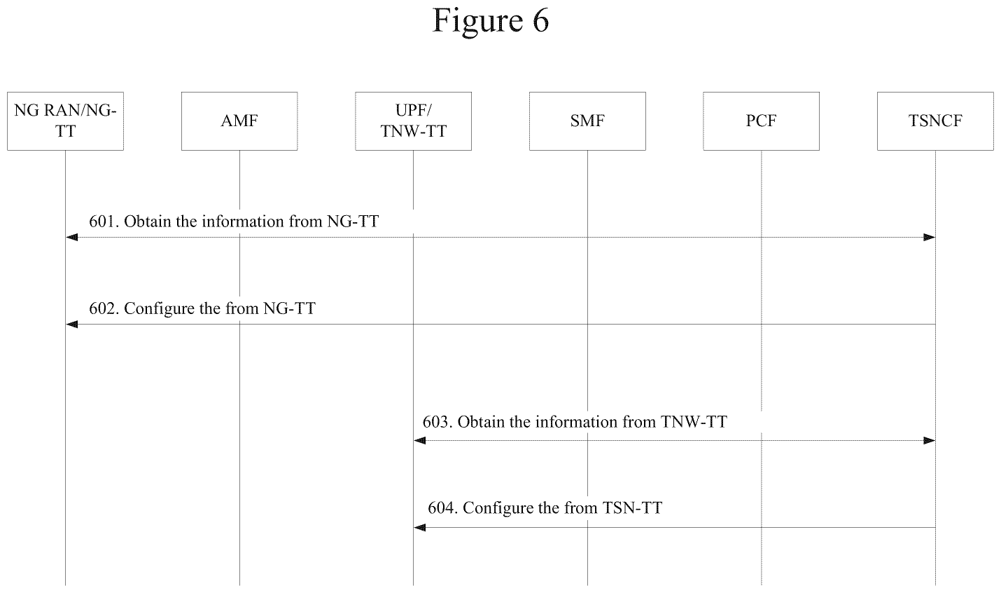

FIG. 6 shows an embodiment of Time Sensitive Networking (TSN) information communication. Specifically, FIG. 6 shows a logic interaction between TSNCF and NG-RAN/NW-TT, and between TSNCF and UPF/TNW-TT. The TSNCF may configure the NG-RAN/NW-TT. In block 601, the TSNCF obtains the TSN information (e.g. TSN end station capability, stream information, time information, etc.) from the NG-TT/NG-RAN. The TSNCF may be in TSN AF, SMF, PCF, or TSCTSF in the existing cellular/5GS network, or it may be a new network function. In this example, the interaction signaling between TSNCF and NG-RAN/NG-TT may be via NG-RAN-AMF-SMF-PCF-TSNCF. If the TSNCF is in PCF, the interaction between TSNCF and NG-RAN/NG-TT may be via NG-RAN-AMF-SMF-PCF/TSNCF. If the TSNCF is in SMF, the interaction between TSNCF and NG-RAN/NG-TT may be via NG-RAN-AMF-SMF/TSNCF. Before the NG-RAN/NG-TT sends the TSN information to TSNCF, the TSNCF may send request to NG-RAN/NG-TT via the above signaling path.

In block 602, the TSNCF configures the NG-TT. The TSNCF sends configurations to NG-RAN/NG-TT via above signaling path according to the TSNCF location. In block 603, the TSNCF obtains the TSN information (e.g. the TSN end station capability, stream information, time information, etc.) from the TNW-TT/UPF. The TSNCF can be in TSN AF, SMF, PCF, or TSCTSF in the cellular/5GS network, or it may be a new network function. In this example, the interaction signaling between TSNCF and TNW-TT/UPF may be via TNW-TT/UPF-SMF-PCF-TSNCF. If the TSNCF is in the PCF, the interaction between TSNCF and TNW-TT/UPF may be via TNW-TT/UPF-SMF-PCF/TSNCF. If the TSNCF is in the SMF, the interaction between TSNCF and TNW-TT/UPF may be via TNW-TT/UPF-SMF/TSNCF. Before the TNW-TT/UPF sends the TSN information to TSNCF, the TSNCF may send a request to TNW-TT/UPF via the above signaling path. In block 604, the TSNCF may configure TNW-TT/UPF by sending a configuration to TNW-TT/UPF via above signaling path based on the TSNCF location.

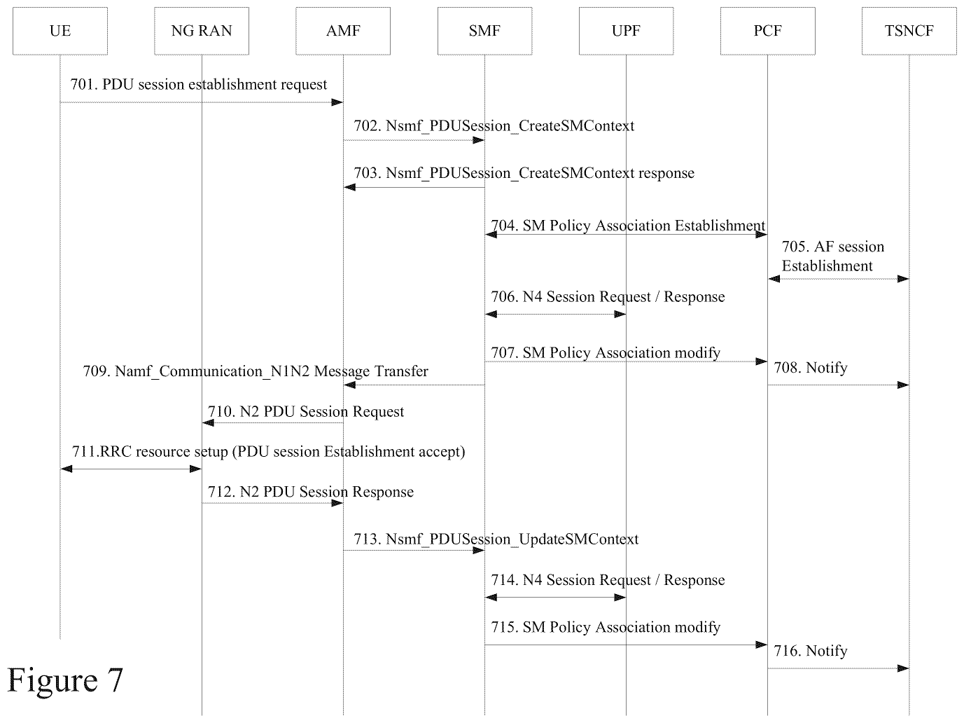

FIG. 7 shows another embodiment of Time Sensitive Networking (TSN) information communication during a Packet Data Unit (PDU) session establishment. In FIG. 7, the TSNCF obtains the TSN information during PDU establishment and shows how the TSNCF obtains the TSN end station information. The TSN information may include TSN end station capability, end station address, etc. The TSN information may be from NG-TT and TNW-TT.

In block 701, the UF/TT send a PDU Session establishment Request to the AMF. In block 702, the AMF invoke Nsmf_PDUSession_CreateSMContext service operation towards the SMF. In block 703, the SMF send Nsmf_PDUSession_CreateSMContext responds to the AMF. In block 704, the SMF initiates an SM Policy Association establishment with the PCF. The SMF sends the Npcf_SMPolicyControl_Create operation. In block 705, the AF session is established between the PCF and TSNCF. The PCF may notify TSCTSF using Npcf_PolicyAuthorization_Notify. The TSNCF may then initiate the AF session establishment with Npcf_PolicyAuthorization service.

In block 706, the SMF sends an N4 session request to UPF to establish the N4 session. The UPF/TNW-TT responds with the TSN end station information of the TNW-TT to the SMF. In an alternative embodiment, the SMF may include end station capability request indication with the N4 session request. The TNW-TT information may include the UPF handle time. In block 707, the SMF sends TSN end station information to the PCF in the SM Policy Association modify by sending Npcf_SMPolicyControl_Update. In block 708, the PCF sends TSN end station information to TSNCF in the AF session Notify by sending Npcf_PolicyAuthorization_Notify. In some embodiments, block 705 may be performed after block 707.

In block 709, the SMF invokes Namf_Communication_N1N2MessageTransfer to AMF which include the N2 SM information, N1 SM container. In an alternative embodiment, the SMF may include an end station capability request indication in this request. In block 710, the AMF sends the N2 PDU Session Request to NG-RAN/NG-TT. In block 711, the NG-RAN/NG-TT uses the QoS information in the N2 SM information for radio resource establishment and sends an N1 SM container to the UE in radio resource control (RRC) signaling to accept the PDU Session Establishment. In block 712, the NG-RAN/NG-TT sends N2 PDU Session response to AMF. The NG-TT TSN information is carried in the response. In block 713, the AMF invokes Nsmf_PDUSession_UpdateSMContext service operation towards the SMF, which carries the N2 response received from the NG-RAN/NG-TT. In block 714, the SMF updates the N4 session with UPF. The UPF/TNW-TT may respond with the TSN end station information to the SMF in this block. In an alternative embodiment, the SMF may include an end station capability request indication with the N4 session request. In block 715, the SMF sends TSN end station information to the PCF in the SM Policy Association modify by sending Npcf_SMPolicyControl_Update. In block 716, the PCF sends TSN end station information to TSNCF in the AF session Notify by sending NpcfPolicyAuthorization_Notify. In alternative embodiments, blocks 705 and 708 may be after block 715.

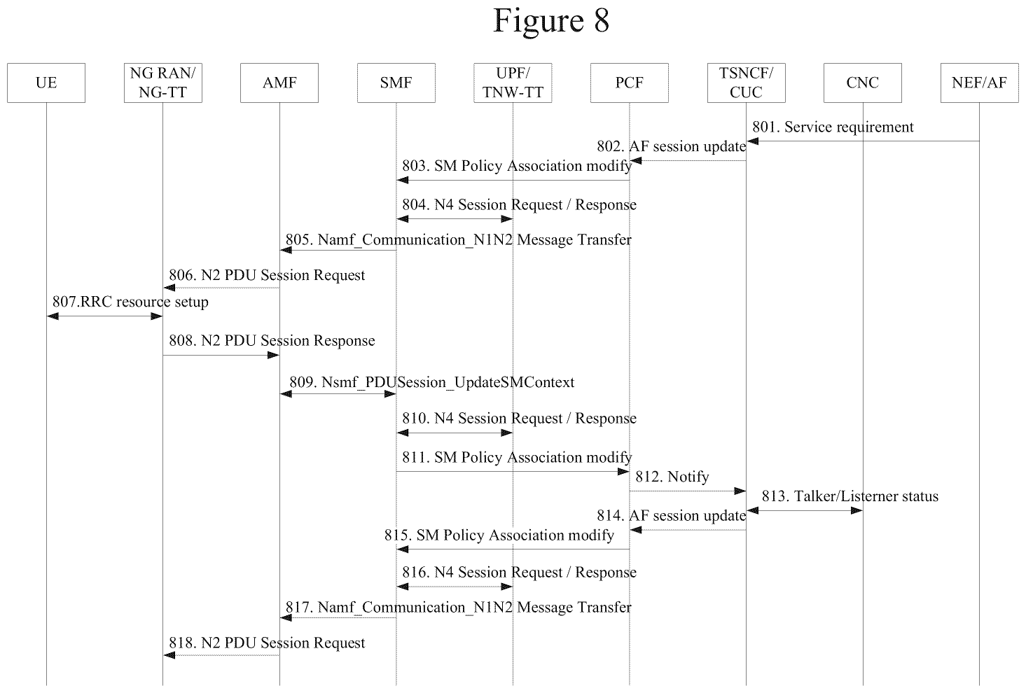

FIG. 8 shows an embodiment of Time Sensitive Networking (TSN) information communication during a Quality of Service (QoS) flow establishment. FIG. 8 shows how the cellular/5GS network uses the TSN capability in the N3 transport network. During the QoS flow establishment for the service flow, the TSNCF collects the N3 transport stream information and sends it to CNC in the transport network. After obtaining the configuration from CNC, the TSNCF sends the configuration to the NG-TT and NTW-TT.

In block 801, the NEF/AF sends the Service and QoS requirement of service flow to TSNCF. This may include service flow information, burst arrival time, periodicity, flow direction, Survival Time, time domain, Requested 5GS delay, or other service parameters. In block 802, the TSNCF determines the Requested PDB and TSC Assistance Container (including Flow Direction, Periodicity, Burst Arrival Time, Survival Time, time domain, etc.) and sends a Requested PDB, TSC Assistance Container and other service flow information in the NpcfPolicyAuthorization_Update request to the PCF. The TSNCF may indicate the NG-TT and TNW-TT should report the TSN end station information. In block 803, the PCF determines the QoS parameters (e.g. 5QI, PDB, etc) for the service flow. The PCF sends the QoS parameters and/or TSC Assistance Container to the SMF. The request from the TSNCF to the NG-TT and TNW-TT may also be sent to the SMF. In block 804, the SMF creates the TSCAI according to the Assistance Container. In some embodiments, according to the received QoS parameters, the SMF determines whether to create a new QoS flow or modify the existing QoS flow.

The SMF may send the N4 session update request to UPF/TNW-TT to create new or modify QoS flow(s). The request from the TSNCF for the TNW-TT may also be sent to the UPF/TNW-TT. The UPF/TNW-TT return the TSN end station information to the SMF. This information may be sent to the TSNCF. The TSN end station information may include: the NTW-TT Address (MAC address, or IP address), interface name, stream information, stream time information, or other information/parameters. The UPF allocates the CN-tunnel resource for the QoS flow and returns the Fully Qualified TEID (F-TEID) for the QoS flow to the SMF.

In block 805, the SMF invokes Namf_Communication_N1N2MessageTransfer to AMF. It may include the N2 SM container, CN-tunnel information, N1 SM container, TSCAI, and/or request for the NG-TT. The request for the NG-TT may be in the N2 SM container. In block 806, the AMF sends N2 PDU Session Request to the NG-RAN/NG-TT. It may include an N2 SM container, N1 SM container, TSCAI, and/or request for NG-TT. The request for the NG-TT may be in the N2 SM container. In block 807, the NG-RAN/NG-TT may perform AN specific signaling exchange (e.g. RRC resource setup) with the UE that is related with the information received from the SMF.

In block 808, the NG-RAN/NG-TT send the N2 response to AMF. The response includes the RAN-tunnel information (F-TEID) for the QoS flow, and the NG-TT TSN end station information. The TSN end station information may include: NG-TT Address (MAC address, or IP address), interface name, stream information, stream time information, or other information/parameters. In block 809, the AMF invokes Nsmf_PDUSession_UpdateSMContext service operation towards SMF, which carries the N2 response received from NG-RAN/NG-TT. In block 810, the SMF updates the N4 session with the UPF. The UPF/TNW-TT may respond with the TSN end station information to the SMF in this block. The UPF/TNW-TT returns the TSN end station information to the SMF. In some embodiments, the TSN end station information in block 804 may be included.

In block 811, the SMF sends TSN end station information (received from NG-TT, TNW-TT) to the PCF in the SM Policy Association modify by sending Npcf_SMPolicyControl_Update. In block 812, the PCF sends TSN end station information to the TSNCF in the AF session Notify by sending Npcf_PolicyAuthorization_Notify. In block 813, the TSNCF/CUC calculates the talker/listener status and sends it to the CNC in the transport network. The CNC returns CUC with the status of stream configuration, including the configuration for the TSN end station (i.e. talker/listener). In some embodiments, this block may be similar to block 503 and block 506 in FIG. 5.

In block 814, the TSNCF sends the TSN configuration received from the CNC to the NG-TT and TNW-TT by invoking Npcf_PolicyAuthorization_Update to the PCF. In block 815, the PCF invokes Npcf_SMPolicyControl_Update to send the TSN configuration to the SMF. In block 816, the SMF sends the N4 session update request to the UPF/TNW-TT to send the TSN configuration for the TNW-TT to the UPF/TNW-TT. In block 817, the SMF invokes Namf_Communication_N1N2MessageTransfer to the AMF. It carries the TSN configuration for the NG-TT. In block 818, the AMF sends the N2 PDU Session Request to the NG-RAN/NG-TT. It may include the TSN configuration for the NG-TT.

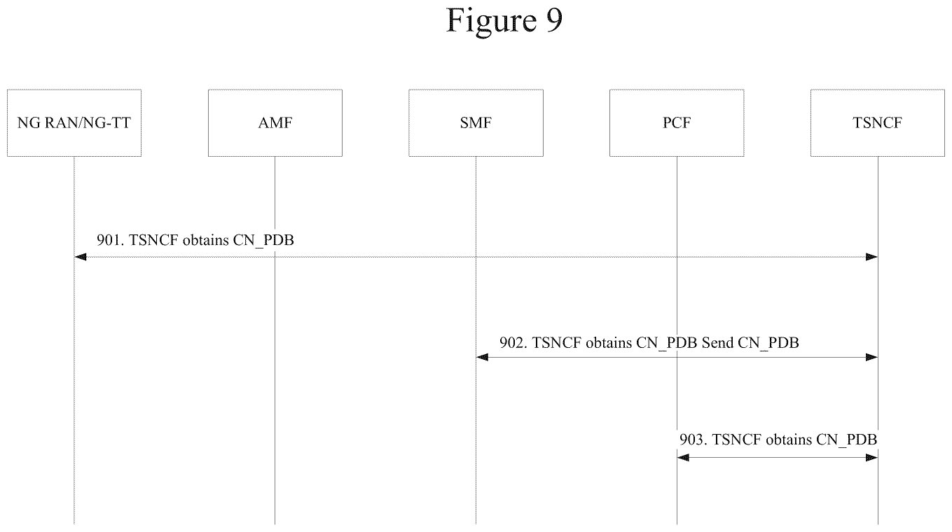

FIG. 9 shows an embodiment of a network (e.g. 5GS) and transport network with latency communications. In FIG. 9, the TSNCF obtains the delay requirement in N3 transport and shows how the TSNCF obtains the CN_PDB. The CNC may need the E2E delay in the transport network between talker and listener (i.e. N3 delay) to determine the E2E path and schedule the resource. The N3 delay may be the Core Network Packet Delay (CN PDB). In block 901, the TSNCF obtains the CN_PDB for the data flow from the NG-RAN/NG-TT. The NG-RAN/NG-TT sends the CN_PDB to the TSNCF via the AMF, the SMF and/or the PCF as in blocks 808, 809, 811, and 812. In alternative embodiments, the TSNCF may request the NG-RAN/NG-TT to report the CN_PDB via PCF, SMF, AMF (e.g. in blocks 802, 803, 805, and 806.

In an alternative embodiment shown in block 902, the TSNCF obtains the CN_PDB for the data flow from SMF. The SMF sends the CN_PDB to the TSNCF via PCF. This may be similar to blocks 811 and 812. In an alternative embodiment, the TSNCF may request the SMF to report the CN_PDB via PCF as in blocks 802 and 803.

In an alternative embodiment shown in block 903, the TSNCF obtains the CN_PDB for the data flow from PCF. The PCF sends the CN_PDB to TSNCF as in block 812. In an alternative embodiment, the TSNCF may request the PCF to report the CN_PDB via PCF as in block 802.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for wireless communication, comprising:
obtaining a Time Sensitive Networking (TSN) capability; and
obtaining a latency requirement.

2. The method of claim 1, wherein the obtaining the TSN capability is by a TSN Centralized User Configuration Function (TSNCF).

3. The method of claim 2, wherein the obtaining the TSN capability is during a Packet Data Unit (PDU) session establishment or Quality of Service (QoS) flow setup.

4. The method of claim 1, further comprising:
obtaining stream requirement for the QoS flow setup.

5. The method of claim 4, wherein the stream requirement comprises stream information, stream time information, a basestation address, or a User Plane Function (UPF) address.

6. The method of claim 1, wherein the obtaining of the latency requirement further comprises:
receiving, by a TSN Centralized User Configuration Function (TSNCF), the CN PDB from a basestation, a Session Management Function (SMF), or a Policy Control Function (PCF).

7. The method of claim 1, further comprising:
sending, by a TSN Centralized User Configuration Function (TSNCF), a talker/listener status to a Centralized Network Configuration (CNC).

8. The method of claim 7, further comprising:
receiving, by the TSNCF, a configuration from Centralized Network Configuration (CNC); and
sending, by the TSNCF, the configuration to a basestation and a User Plane Function (UPF).

9. The method of claim 6, wherein the TSNCF comprises a TSN Application Function (TSN AF), a Policy Control Function (PCF), a Session Management Function (SMF), or a Time Sensitive Communication and Time Synchronization function (TSCTSF).

10. The method of claim 1, wherein the latency requirement comprises a Core Network Packet Delay (CN PDB) latency.

11. A method for wireless communication, comprising:
sending a Time Sensitive Networking (TSN) capability; and
sending during a Quality of Service (QoS) flow establishment, a stream requirement.

12. The method of claim 11, wherein the sending, is by the basestation or User Plane Function (UPF).

13. The method of claim 12, wherein the sending is to a TSN Centralized User Configuration Function (TSNCF) and is during a Packet Data Unit (PDU) session establishment or Quality of Service (QoS) flow setup.

14. The method of claim 11, wherein the stream requirement comprises stream information, stream time information, or a basestation address or User Plane Function (UPF) address.

15. The method of claim 11, further comprising:
sending a latency requirement.

16. The method of claim 15, wherein the sending the latency requirement is by a basestation, a Session Management Function (SMF), or a Policy Control Function (PCF).

17. The method of claim 15, wherein the latency requirement comprises a Core Network Packet Delay (CN PDB) latency.

18. A method for wireless communication, comprising:
obtaining a Time Sensitive Networking (TSN) capability; and
obtaining, during a during a Quality of Service (QoS) flow establishment, a stream requirement.

19. The method of claim 18, wherein the obtaining the TSN capability is by a TSN Centralized User Configuration Function (TSNCF).

20. The method of claim 19, wherein the obtaining the TSN capability is during a Packet Data Unit (PDU) session establishment or Quality of Service (QoS) flow setup.
